(19) United States
(12) Patent Application Publication
(10) Pub. No.: US 2025/0159051 A1
(43) Pub. Date: May 15, 2025

(54) Method for Communicating in a Communication System Having Power Tools, Communication System, and Power Tool

(71) Applicant: Robert Bosch GmbH, Stuttgart (DE)

(72) Inventors: Jan Koegel, Zusmarshausen (DE); Cankal Altun, Stuttgart (DE); Abhishek Joshi, Stuttgart (DE)

(21) Appl. No.: 18/838,181

(22) PCT Filed: Dec. 27, 2022
(86) PCT No.: PCT/EP2022/087915

§ 371 Date: Aug. 13, 2024

(30) Foreign Application Priority Data
Feb. 16, 2022 (DE) 10 2022 201 576.2

(51) Int. Cl. H04L 67/125; B25F 5/00

(52) U.S. Cl. CPC H04L 67/125; B25F 5/00

(57) ABSTRACT

A method is for communicating in a communication system having power tools which each form an edge node in the communication system and a network unit arranged at an operating location of the power tools and connected directly to the power tools by a wireless connection, in particular a WLAN/WiFi connection, a Bluetooth low-energy connection, and/or a LoRaWAN connection. The communication system further having at least one terminal, in particular a computer, a smartphone, and/or a charger, which is/are provided as a user interface for the network unit. Data relating to the power tools are collected and processed by the network unit in at least one method step for cognitive data processing, and the power tools are controlled or regulated by the network unit in at least one further method step by a local closed control or regulating circuit.

### PRIOR ART

A method for communicating in a communication system having power tools which each form an edge node in the communication system, having a network unit, in particular a network unit in the form of a gateway, which is arranged, in particular, at the operating location of the power tools and is connected directly to the power tools by means of a wireless connection, in particular a WLAN/WiFi connection, a Bluetooth low-energy connection, and/or a LoRaWAN connection, and having at least one terminal, in particular a computer, a smartphone, and/or a charger, which is/are provided as the user interface for the network unit, has already been proposed.

### DISCLOSURE OF THE INVENTION

The invention is based on a method for communicating in a communication system having power tools which each form an edge node in the communication system, having a network unit, in particular a network unit in the form of a gateway, which is arranged, in particular, at the operating location of the power tools and is connected directly to the power tools by means of a wireless connection, in particular a WLAN/WiFi connection, a Bluetooth low-energy connection, and/or a LoRaWAN connection, and having at least one terminal, in particular a computer, a smartphone, and/or a charger, which is/are provided as the user interface for the network unit.

It is proposed that data relating to the power tools are collected and processed by the network unit in at least one method step for cognitive data processing, and the power tools are controlled or regulated by the network unit in at least one further method step by means of a local closed control or regulating circuit.

Preferably, the communication system is provided to create secure communication, in particular secure data exchange, between the subscribers in the communication system in order to be able to store and process the data of the power tools. The term “provided” is understood in particular as meaning specifically programmed, designed and/or equipped. In particular, the phrase “an object being provided for a specific function” is intended to mean that the object fulfills and/or performs this specific function in at least one application state and/or operating state. The operating location is in particular formed from a spatially limited area, which forms a current location of use of the power tools. Preferably, the operating location is configured as a plant site, a company site, a worksite, and/or a company location. Preferably, all power tools of the communication system are located at the same operating location. Preferably, the network unit is in the same operating location as the power tools. The power tools are preferably configured as hand-held power tools, sensors, fire detectors, cameras, actuating elements, or other electrical devices located at the operating location that enable data exchange with the network unit. Preferably, each power tool at the operating location forms an edge node. In this context, an “edge node” is to be understood in particular as a subscriber, in particular a node device, in the communication system, which is in particular wirelessly connected to the network unit and is configured to send at least one parameter, in particular a process parameter, influencing parameter, and/or environmental parameter, to the network unit. Preferably, the power tools and thus the edge nodes are each connected directly to the network unit, in particular in terms of data transmission. In particular, the power tools comprise at least one computing unit, at least one storage unit and at least one communication unit. “Configured” is understood in particular as meaning specifically programmed, specifically designed, and/or specifically equipped. In particular, the phrase “an object being configured for a specific function” is intended to mean that the object fulfills and/or performs this specific function in at least one application state and/or operating state.

The network unit is preferably provided to collect, evaluate, filter, and save the data relating to the power tools. Preferably, the network unit is provided to control or regulate the power tools as a function of the captured data. It is contemplated that the wireless connection between the network unit and the power tools is configured as a Bluetooth, Zigbee, Z-Wave, 6LoWPAN, NFC, WiFi Direct, GSM, LTE, NB-IoT, LTE-M, Z-Wave Long Range, Thread, HomeKit, DotDot, and/or a sidewalk connection. The network unit is in particular configured as a Fog unit, a LAN switch, a router, and/or the like in the communication system. Preferably, the network unit is provided to evaluate the data relating to the power tools in real-time at the operating location, in particular without the need for cloud communication, which is particularly time-consuming. Preferably, the network unit comprises a computing unit for processing the data relating to the power tools. Preferably, in a method step, the network unit uses the data relating to the power tools to create a, in particular three-dimensional, device map of the power tools located at the operating location. The device map preferably comprises all power tools located in the operating location. Preferably, in a method step, the device map is generated from the network unit by means of a signal strength of respective power tool signals of the power tools. In a method step, the network unit performs theft monitoring. Preferably, when theft monitoring is performed, it is at least determined whether one of the power tools leaves its operating location and/or an ascribed workplace at the operating location. Preferably, in a method step, tool diagnostics are performed on the power tools by the network unit. In this context, “tool diagnostics” is understood to mean in particular a check of the power tools. In particular, a fault-free function and a battery state of the power tools are checked. Preferably, the terminals are configured as measuring devices, portable terminals, environmental sensors, or the like. In a method step, the terminals preferably access the data relating to the power tools via the network unit. In a method step, the terminals directly access the data relating to the power tools via the power tools.

In this context, “cognitive data processing” is to be understood in particular as independent and intelligent data processing, which simulates human thought processes and is intended for learning, inferring, and/or human-computer interaction. In particular, cognitive data processing is formed from a detection of information, processing of information, and capturing states and behaviors. Preferably, the network unit is configured such that it can derive a conclusion for controlling or regulating the power tools by means of cognitive data processing by at least the captured data of the power tools. In this context, a “local control and/or regulating circuit” is to be understood in particular as a control and/or regulating process, which is carried out in particular at the operating location and is free from communication outside of the network and power tool communication. Preferably, in the method step of controlling or regulating the power tools, a control or regulating signal is wirelessly transmitted from the network unit to the power tools.

The embodiment of the method according to the invention for communication in a communication system with power tools advantageously enables efficient data storage and data evaluation of power tools at an operating location. Advantageously, secure communication between the power tools and the network unit may be provided. Advantageously, data processing of the power tools can be performed quickly and locally at the operating location. In particular, advantageous fast and secure data processing can be enabled independent of the location and in particular independent of an Internet connection. Advantageously, an optimization of the power tools can be achieved in a flexible manner as a function of states of the operating location.

Furthermore, it is proposed that, in at least one method step, a communication, in particular a data exchange, between the network unit and a server unit, in particular a server unit configured as a cloud server, which is arranged in particular outside the operating location of the power tools, takes place, wherein the server unit is in particular connected to the network unit by means of an internet connection, in particular a LAN and/or an LTE connection. The server unit is preferably connected by means of an LPWAN, a Sigfox, a LoRa, an NB-IoT, and/or a similar connection that appears to be useful to a person skilled in the art for communication and data exchange between a server unit and a network unit. Preferably, the server unit, in particular the cloud server, is configured from network devices. The network devices are in particular configured as firewalls, storage arrays, backup devices, servers, or the like. In particular, it should be understood that the server unit is outside of the operating location, and that the physical network devices are located outside of the operating location. Preferably, the network unit is configured as a communication interface between the power tools and the server unit. The network unit is preferably configured to provide the server unit, the power tools, and/or the terminals with data relating to the power tools at the operating location. Preferably, the server unit, in particular the cloud server, stores data transmitted from the network unit to the server unit in a method step. In a method step, the server unit preferably provides the stored data to a user. Preferably, the data is provided to a user via an internet connection. With the design of the method, streams of data between the power tools and the server unit may advantageously be kept low. Only relevant data can advantageously be stored in the server unit.

Furthermore, it is proposed that the cognitive data processing is performed solely by the network unit. Preferably, the cognitive data processing from the network unit is free of interaction from the server unit. Preferably, in a method step, the evaluated data of the cognitive data processing is sent to the server unit. With the design of the method, streams of data between the power tools and the server unit may advantageously be kept low. A regulation or control of the power tools may be provided by means of the network unit having an advantageously higher bandwidth. Advantageously, the latency between power tools and the network unit may be kept low. It is advantageous to be able to optimize the power tools to changing states, in particular the power tools, their requirements, and/or the operating location, free of interaction with the server unit.

Furthermore, it is proposed that, in at least one method step, the network unit, in particular the gateway, uses a computing power of the power tools for data processing. Preferably, the network unit comprises at least one computing unit, a memory unit and a communication unit that are compatible with the power tools, in particular of a similar design. The computing power of the network unit can be advantageously increased by the design of the method.

Furthermore, it is proposed that, in at least one method step, the communication, in particular the data exchange, takes place in the communication system between the network unit and the server unit, in particular at preset time intervals. The time interval is preferably a time interval between two scheduled communications between the network unit and the server unit. Preferably, in a method step, the communication between the network unit and the server unit takes place in a time interval of a maximum of 24 hours, preferably a maximum of 12 hours, more preferably a maximum of 6 hours, and more preferably a maximum of 3 hours. However, the time interval could also have a different time interval that appears to be useful by a person skilled in the art. Preferably, in a method step, filtered data relating to the power tools is transferred to the server unit in the communication between the network unit and the server unit. The design of the method ensures that important data relating to the power tools can be backed up in the server unit. At the same time, in particular, a permanently high load on the data rate can be avoided.

Furthermore, it is proposed that, in at least one method step, the communication, in particular the data exchange, in the communication system is encrypted by means of an asymmetric cryptography, in particular a public key infrastructure. “Asymmetric cryptography” is to be understood in particular to mean an encryption method for data to be communicated between two identities, in particular between the power tools/terminal device and the network unit, between the network unit and the server unit, between two power tools/two terminals and/or between the power tools and the server unit, wherein each identity has different information for encryption and/or decryption of the data. A “public key infrastructure” is to be understood to mean in particular an encryption method, which is based on asymmetric cryptography, wherein at least one private key and at least one public key exist for each identity configured as the recipient of data, and wherein the public key is configured to encrypt data and the private key is configured to decrypt the data encrypted with the public key. Preferably, authentication and/or data transmission of the power tools by/to the server unit or the network unit occur(s) via a connection of the power tools to the server unit via the network unit or with a connection of the power tools to the network unit. However, it is also contemplated that authentication and/or data transfer of the power tools is be performed directly by/to the server unit. It is also contemplated that authentication and/or data transfer of the power tools occur(s) directly by/to the server unit. Preferably, the server unit is configured as the primary decentralized certificate authority of the communication system. The network unit is preferably configured as a local certification authority. In this context, a “certificate authority” is to be understood in particular to mean a security tool for authenticating the subscribers of a communication system. The design of the method can advantageously enable secure communication between multiple power tools and/or between power tools and the network unit/server unit. The configuration can enable an advantageously high confidentiality of a data package. There may be advantageously simple and accurate mapping of power tools in the communication system.

Furthermore, it is proposed that, in at least one method step, the communication, in particular the data exchange of encrypted data, takes place wirelessly and directly between the power tools. Preferably, the communication between the power tools takes place wirelessly, in particular by means of the WLAN/WiFi connection, the Bluetooth low energy connection, and/or the LoRaWAN. The design of the method makes it possible to provide advantageously direct data exchange between power tools.

Furthermore, it is provided that, in at least one method step, in addition to the communication between the power tools and the network unit, the communication, in particular the data exchange of encrypted data, takes place wirelessly and directly between the power tools. Advantageously, secure communication between the machine tool and the server unit can be achieved by the design of the method. Advantageously high functionality of the machine tool can be achieved, in particular as secure networking of the machine tool with the server unit, in particular the Internet, can be enabled.

Furthermore, a communication system for performing a method according to the invention is proposed having power tools which each form an edge node in the communication system, having a network unit, in particular a network unit in the form of a gateway, which is arranged, in particular, at the operating location of the power tools and is connected directly to the power tools by means of a wireless connection, in particular a WLAN/WiFi connection, a Bluetooth low-energy connection, and/or a LoRaWAN connection, and having at least one terminal, in particular a computer, a smartphone, and/or a charger, which is/are provided as the user interface for the network unit. Preferably, the network unit comprises at least a storage unit, a computing unit and a communication unit. The storage unit of the network unit is preferably provided for storing the data relating to the power tools. The computing unit of the network unit is preferably provided to enable cognitive data processing. The terminals are preferably provided to read and/or process the data relating to the power tools from the network unit. Preferably, the communication system comprises at least one server unit, in particular a cloud server. The server unit is preferably configured to provide an access option for the terminals for data reading and/or processing. Preferably, the power tools are configured in the communication system to provide an access option for the terminals in the communication system for data reading and/or processing. Preferably, the communication system, in particular the power tools, is configured such that the power tools can be regulated or controlled directly from the terminal device. The design of the communication system according to the invention may advantageously enable efficient data storage and data evaluation of power tools at an operating location. Advantageously, secure communication between the power tools and the network unit may be provided. Advantageously, data processing of the power tools can be performed quickly and locally at the operating location. Advantageously, an optimization of the power tools can be achieved in a flexible manner as a function of states of the operating location.

Furthermore, a power tool of a communication system according to the invention is proposed, which forms an edge node in the communication system, having at least one storage unit, a computing unit and a communication unit, which is provided for, in particular wireless, transmission of data to at least one network unit, wherein the communication unit is configured, such that the power tool can be controlled or regulated by means of the network unit, as a function of cognitive data processing. The storage unit of the network unit is preferably provided for storing the data relating to the power tools. The computing unit of the power tools is preferably provided for processing the data of the power tools. The network unit is preferably provided for secure communication with the network unit, the server unit and/or the terminal devices. Advantageously, high functionality can be achieved by the embodiment of the electric tool according to the invention, in particular because the electric machine can be connected to the network unit and/or the server unit via a secure connection. Advantageously accurate monitoring of the power tool may be enabled, particularly when used with further power tools at a common operating location.

Furthermore, it is proposed that the computing unit is configured such that the network unit can access a computing power of the computing unit to perform the cognitive data processing. Advantageously efficient data processing can be carried out with the design of the power tool.

The method according to the invention, the communication system according to the invention, and/or the power tool according to the invention should not thereby be limited to the application and embodiment described above. In particular, the method according to the invention, the communication system according to the invention, and/or the power tool according to the invention can have a number of individual elements, components, and units as well as method steps that differs from a number mentioned herein in order to fulfill a mode of operation described herein. Moreover, regarding the ranges of values indicated in this disclosure, values lying within the limits specified hereinabove are also intended to be considered as disclosed and usable as desired.

### DRAWINGS

Further advantages follow from the description of the drawings hereinafter. An exemplary embodiment of the invention is shown in the drawing. The drawings, the description, and the claims contain numerous features in combination. A person skilled in the art will appropriately also consider the features individually and combine them into additional advantageous combinations.

Shown are:

FIG. 1 a method according to the invention and a communication system according to the invention in a schematic representation,

FIG. 2 a part of the communication system according to the invention in a schematic diagram having four power tools communicating according to the method according to the invention,

FIG. 3 a further part of the communication system according to the invention in a schematic diagram having two network units communicating according to the method, and

FIG. 4 a further part of the communication system according to the invention having a server unit and two power tools communicating with each other according to the method, in a schematic representation.

### DESCRIPTION OF THE EMBODIMENT EXAMPLE

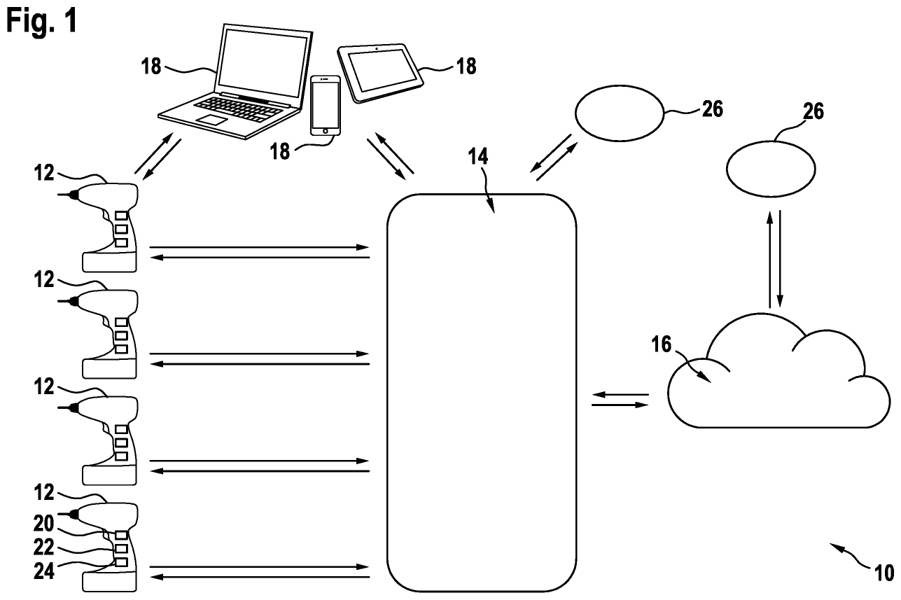

FIG. 1 shows a method for communicating in a communication system 10 having power tools 12. The power tools 12 each form an edge node in the communication system 10. The communication system 10 comprises a network unit 14, in particular a network unit 14 in the form of a gateway. The network unit 14 is arranged at the operating location of the power tools 12. The network unit 14 is wirelessly connected to the power tools 12. The network unit 14 is directly connected to the power tools 12 by means of a WLAN/WiFi connection, a Bluetooth low energy connection, and/or a LoRaWAN connection. The network unit 14 is connected to at least one terminal 18, which is provided as a user interface for the network unit 14. For example, terminal 18 may be formed by a computer, smartphone, and/or charger. In a method step, data relating to the power tools 12 is collected and processed by the network unit 14 for cognitive data processing. Using the data, in a further method step, the power tools 12 are controlled or regulated by the network unit 14 by means of a local closed control or regulating circuit. In a method step, the data relating to the power tools 12 is captured, evaluated, filtered, and stored by the network unit 14. The communication system 10 shown in FIG. 1 comprises four power tools 12 which each form the edge node in the communication system 10. The communication system 10 comprises the network unit 14, in particular the network unit 14 in the form of a gateway. The communication system 10 includes three terminals 18. The terminal devices 18 are configured in particular as a computer, smartphone, and/or a tablet. The communication system 10 includes two local servers 26. The local server 26 is in particular formed from a local data store, in particular a file server. The local server 26 is in particular integrated in a local network of the operating location. The local servers 26 are arranged at the operating location of the power tools 12. The network unit 14 and a server unit 16 of the communication system 10 are configured to allow the local servers 26 to access their data. The network unit 14 comprises a secured data store. The secured data store has two security classes for the stored data. A first one of the two security classes is provided for a first portion of the data store having a normal security level. The first portion of the data store comprises impersonal data of the subscribers of the communication system 10. A second one of the two security classes is provided for a second portion of the data store having an increased security level. The second portion of the data store comprises personal data of the subscribers of the communication system 10.

In a method step, communication takes place, in particular a data exchange, between the network unit 14 and the server unit 16, in particular a server unit 16 configured as a cloud server. The server unit 16 is arranged outside the operating location of the power tools 12. The server unit 16 is connected to the network unit 14 via an internet connection, in particular a LAN and/or an LTE connection. The server unit 16 is configured as a cloud server of network devices. The network devices are, among other things, configured as firewalls, storage arrays, backup devices, servers, or the like. The network unit 14 is configured as a communication interface between the server unit 16 and the power tools 12. In a method step, the server unit 16, in particular the cloud server, stores data transmitted from the network unit 14 to the server unit 16. In a method step, the server unit 16 provides the stored data to a user. The data is provided to a user via an internet connection in a method step.

The server unit 16 comprises a secure data store. The secured data store has two security classes for the stored data. A first one of the two security classes is provided for a first portion of the data store having a normal security level. The first portion of the data store comprises impersonal data of the subscribers of the communication system 10. A second one of the two security classes is provided for a second portion of the data store having an increased security level. The second portion of the data store comprises personal data of the subscribers of the communication system 10.

The cognitive data processing is performed solely by the network unit 14. The cognitive data processing of the network unit 14 is free of interaction with the server unit 16. For example, in a method step, an increased concentration of dust in the air at the operating location is detected by a power tool 12 configured as a dust measuring device. In a further method step, the signal of the sensor is evaluated by the network unit 14 by means of the data processing. In a further method step, the network unit 14 communicates with a power tool 12 configured as a dust removal unit as a result of the data processing. In a further method step, the dust removal unit is switched on, controlled or regulated by means of the communication from the network unit 14. In a method step, the evaluated data of the data processing is sent from the network unit 14 to the server unit 16. In a method step, the network unit 14, in particular the gateway, uses a computing power of the power tools 12 for data processing. In a method step, the communication, in particular the data exchange, takes place in the communication system 10 between the network unit 14 and the server unit 16, in particular at preset time intervals. The time intervals may be set by a user via the server unit 16. In a method step, the communication, in particular the data exchange, in the communication system 10 is encrypted by means of an asymmetric cryptography, in particular a public key infrastructure. In a method step, authentication and/or data transmission of the power tools 12 by/to the server unit 16 or the network unit 14 occur(s) via a connection of the power tools 12 to the server unit 16 via the network unit 14 or with a connection of the power tools 12 to the network unit 14. However, it is also contemplated that authentication and/or data transfer of the power tools 12 occur(s) directly by/to the server unit 16 in a method step. It is also contemplated that authentication and/or data transfer of the power tools 12 occur(s) directly by/to the server unit in a method step. The server unit 16 is configured as the primary decentralized certificate authority of the communication system 10. The network unit 14 is preferably configured as a local certification authority. Both the network unit 14 and the server unit 16 have an additional security memory, in which the respective certification data of the subscribers of the communication system 10 are stored.

The power tool 12 is configured as the edge node in the communication system 10. The power tools 12 shown in FIG. 1 are configured as hand-held power tools. However, the power tools 12 could also be configured as smartphones, sensors, fire detectors, operation elements, cameras, or the like. The power tool 12 comprises a storage unit 20, a computing unit 22, and a communication unit 24. The communication unit 24 is provided for transmitting data, in particular wirelessly, to at least the network unit 14. The communication unit 24 is configured such that the power tool 12 can be controlled or regulated by means of the network unit 14 as a function of the cognitive data processing. The computing unit 22 is configured such that the network unit 14 can access a computing power of the computing unit 22 to perform the cognitive data processing (FIG. 1). The network unit 14 comprises computing units, memory units and communication units that are compatible with the power tools 12, in particular of a similar design.

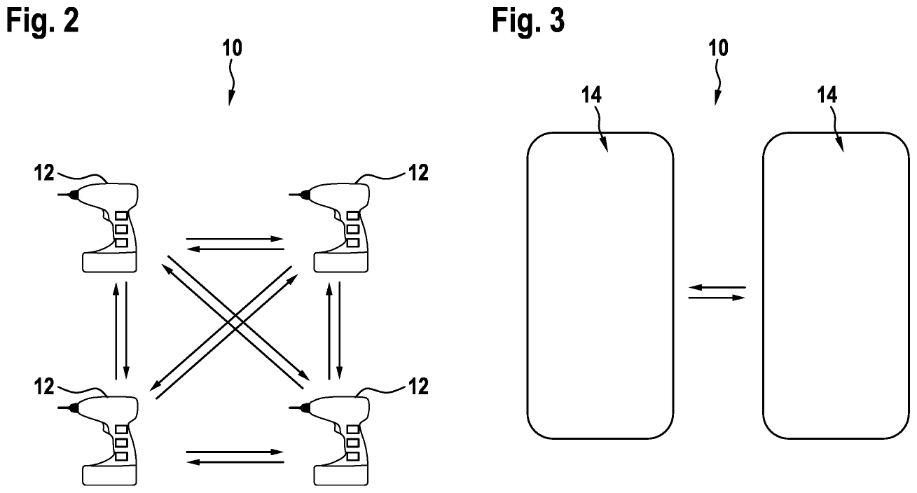

In a method step, the communication, in particular the data exchange of encrypted data, takes place wirelessly and directly between the power tools 12 (FIG. 2). The communication between the power tools 12 takes place wirelessly in a method step. The communication between the power tools 12 takes place wirelessly in a method step by means of the WLAN/WiFi connection, the Bluetooth low energy connection, and/or the LoRaWAN.

The communication system 10 in FIG. 3 comprises two network units 14. In a method step, communication takes place wirelessly and directly between the two network units 14. In a method step, the two network units 14 exchange data relating to the power tools 12 located in the communication system 10. In a method step, the data exchange between the two network units 14 is encrypted by means of asymmetric cryptography.

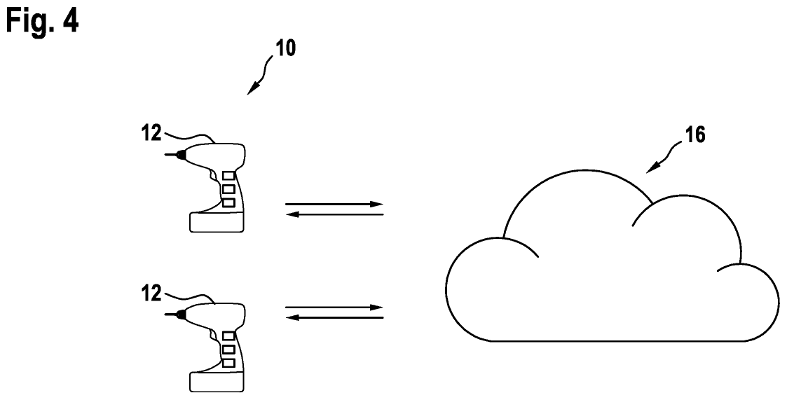

In a method step, in addition to the communication between the power tools 12 and the network unit 14, the communication, in particular the data exchange of encrypted data, takes place wirelessly and directly between the power tools 12 and the server unit 16 (FIG. 4). In a method step, the data relating to the power tools 12 is transmitted directly to the server unit 16 and stored in the server unit 16. In a method step, the data stored in the server unit 16 is read by a user by means of the terminals 18. In a method step, the user is verified when the accessing the server unit 16. In a method step, the data exchange is encrypted by means of asymmetric cryptography when the user accesses the server unit 16.

1. A method for communicating in a communication system having (i) power tools, each power tool forming an edge node in the communication system, (ii) a network unit arranged at an operating location of the power tools and connected directly to the power tools by a wireless connection, and (iii) at least one terminal configured as a user interface for the network unit, the method comprising:
collecting and processing data relating to the power tools using the network unit for cognitive data processing; and
controlling or regulating the power tools using the network unit according to a local closed control or regulating circuit.

2. The method according to claim 1, further comprising:
communicating between the network unit and a server unit arranged outside the operating location,
wherein the server unit is connected to the network unit by an internet connection.

3. The method according to claim 2, further comprising:
performing the cognitive data processing solely by the network unit.

4. The method according to claim 1, wherein the network unit uses a computing power of the power tools for the cognitive data processing.

5. The method according to claim 2, wherein the communication takes place in the communication system between the network unit and the server unit at preset time intervals.

6. The method according to claim 2, wherein the communication in the communication system is encrypted by an asymmetric cryptography including a public key infrastructure.

7. The method according to claim 6, wherein the communication takes place wirelessly and directly between the power tools.

8. The method according to claim 6, wherein in addition to the communication between the power tools and the network unit, the communication takes place wirelessly and directly between the power tools and the server unit.

9. A communication system, comprising:
a plurality of power tools, each power tool configured to form an edge node in the communication system;
a network unit configured as a gateway and arranged at an operating location of the plurality of power tools, the network unit connected directly to the plurality of power tools by a WLAN/WiFi connection, a Bluetooth low-energy connection, and/or a LoRaWAN connection; and
at least one terminal configured as a user interface for the network unit,
wherein the network unit is configured (i) to collect and process data relating to the plurality of power tools for cognitive data processing, and (ii) to control or regulate the power tools using according to a local closed control or regulating circuit.

10. A power tool of the communication system according to claim 9, the power tool comprising:
at least one storage unit;
a computing unit; and
a communication unit configured for wireless transmission of data to the network unit,
wherein the communication unit is configured, such that the power tool is controlled or regulated by the network unit as a function of the cognitive data processing.

11. The power tool according to claim 10, wherein the computing unit is configured such that the network unit accesses a computing power of the computing unit to perform the cognitive data processing.
